(19) United States
(12) Patent Application Publication
(10) Pub. No.: US 2017/0349115 A1
(43) Pub. Date: Dec. 7, 2017

(54) ELECTRONIC DEVICE HOLDING SYSTEM AND METHODS OF OPERATING THE SAME

(71) Applicant: Frank Visconti, Lake Forest, IL (US)

(72) Inventor: Frank Visconti, Lake Forest, IL (US)

(21) Appl. No.: 15/615,486

(22) Filed: Jun. 6, 2017

Related U.S. Application Data
(60) Provisional application No. 62/346,217, filed on Jun. 6, 2016.

(51) Int. Cl. B60R 11/02; H01R 13/639; B60R 11/00

(52) U.S. Cl. CPC B60R 11/0211; H01R 13/639; B60R 2011/0078

(57) ABSTRACT

A holding unit including an upper support unit, a lower support unit, a first arm that engages first openings in the upper support unit and lower support unit, a second arm that engages second openings in the upper support unit and lower support unit, and at least two locking openings in the upper support that engages a projection on each first arm and each second arm.

### PRIORITY CLAIM

The present disclosure is a Non-Provisional patent application claiming the benefit of and priority to U.S. Provisional Patent Application No. 62/346,217 filed on Jun. 6, 2016, which is incorporated by reference herein in its entirety.

### BACKGROUND OF THE INVENTION

Electronic devices have become more mobile and widely used for entertainment. As a result, users typically have a need to mount electronic devices on different structures to simplify viewing of images on electronic devices. In the automotive context, users desire a device that allows a monitor or tablet to be mounted in the vehicle that is easy to remove and allows for passengers in back seats of the vehicles to view images displayed on the electronic device.

Automotive mounting units typically require the removal of the head rest of a seat to secure the mounting unit to the seat. However, this requires a physical rearrangement of the seat to install the mounting unit. Further, automotive head rests vary in size and shape depending on the manufacturer of the vehicle. This makes installation and configuration of mounting units difficult.

Therefore, a need exists for a mounting unit that will easily install on a seat to allow users behind the seat to view images on an electronic device affixed to the mounting unit.

### BRIEF SUMMARY OF THE INVENTION

One embodiment of the present disclosure includes a holding unit including an upper support unit, a lower support unit, a first arm that engages first openings in the upper support unit and lower support unit, a second arm that engages second openings in the upper support unit and lower support unit, and at least two locking openings in the upper support that engages a projection on each first arm and each second arm.

In another embodiment, the end of the first arm is substantially curved.

In another embodiment, the end of the second arm is substantially curved.

In another embodiment, the first support and second support move along the first arm and second arm.

In another embodiment, to convert the holding unit from a storage configuration to a mounting configuration, the first arm and second arm are pulled away from the lower support thereby pulling the upper support with the arms.

In another embodiment, an electronic device is secured to the lower support unit.

In another embodiment, the electronic device is secured to the lower support unit by screws.

In another embodiment, the electronic device is secured to the lower support unit by hook and latch material.

In another embodiment, the electronic device is secured to the lower support unit by magnets.

In another embodiment, the arms and support units are made of plastic.

Another embodiment of the present disclosure includes a method of securing an electronic device, the method including attaching an electronic device to a support unit, moving a first arm relative to a second arm such that the first arm and second arm move away from one another, rotating a first are and a second arm such that the first arm and second arm are parallel to one another and are perpendicular to the support units securing the first arm and second arm on a fixture.

In another embodiment, the end of the first arm is substantially curved.

In another embodiment, the end of the second arm is substantially curved.

In another embodiment, the first support and second support move along the first arm and second arm.

In another embodiment, the fixture is a car seat.

In another embodiment, an electronic device is secured to the lower support unit.

In another embodiment, the electronic device is secured to the lower support unit by screws.

In another embodiment, the electronic device is secured to the lower support unit by hook and latch material.

In another embodiment, the electronic device is secured to the lower support unit by magnets.

In another embodiment, the arms and support units are made of plastic.

### BRIEF DESCRIPTION OF THE SEVERAL VIEWS OF THE DRAWING

FIG. 1 depicts a back view of the holding unit;

FIG. 2 depicts a perspective view of a holding unit with the arms and extended in the mounting position;

FIG. 3 depicts a front view of the holding unit with the arms in the retracted position; and

FIG. 4 depicts a locking opening 302 and projection.

### DETAILED DESCRIPTION OF THE INVENTION

The present disclosure relates to a holding unit for an electronic device. The holding unit includes two arms that are removably affixed to a structure, such as, but not limited to, the seat of a car. Two support units are slidably connected to the arms such that the support units move toward each other in a storage position and away from each other in a mounting positions. Locking units on each arm engage openings in the support units to hold the arms in an open position that prevents the support units from moving when the unit is mounted.

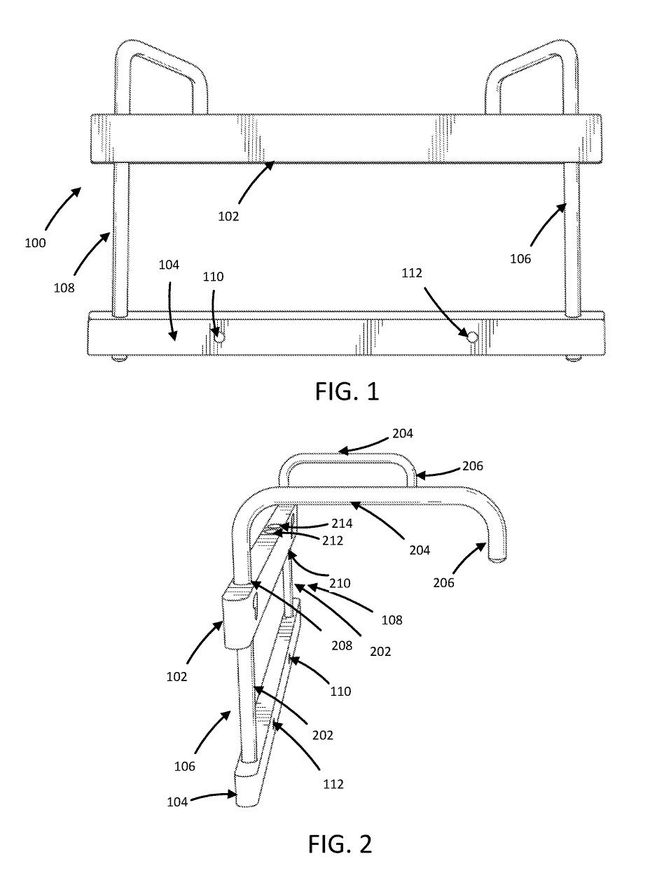

FIG. 1 depicts a back view of the holding unit 100. The holding unit 100 includes an upper support 102 and a lower support 104. Each support 102 and 104 includes openings (not shown) that are slidably affixed to a first arm 106 and a second arm 108 such that the upper support 102 and lower support 104 can move towards and away from each other along the arms 106 and 108. The lower support 104 includes openings 110 and 112 extending through the support 104. The openings 110 and 112 are sized to accept a securing unit that secures a digital device or mount to the holding unit 100. Because the upper support unit 102 moves in relation to the lower support unit 104, the holding unit 100 can accommodate different sizes of electronic devices by moving the upper support 102 further or closer to the lower support 102 to adjust to different devices.

FIG. 2 depicts a perspective view of a holding unit 100 with the arms 106 and 108 extended in the mounting position. Each arm 106 and 108 consists of a base portion 202 and an engagement portion 204. The engagement portion 204 is substantially perpendicular to the base portion 202. An end 206 of the engagement portion 204 may be curved such that the end 206 is perpendicular to the engagement portion 204 and parallel to the base portion 202. By curving the end 206, the holding unit 100 is prevented from rotating off the structure thereby improving the mounting of the holding unit 100 on the structure. The base portion 202 of each arm 106 and 108 engages openings 208 and 210 on the upper support 102 such that each arm 106 and 108 can rotate along an axis extending through a centerline of the base portion 202 of each arm 106 and 108. Openings 212 and 214 on a top surface of the upper support 102 are formed to engage each end 206 of the arms 106 and 108 to hold the arms 106 and 108 in a retracted position when not in use.

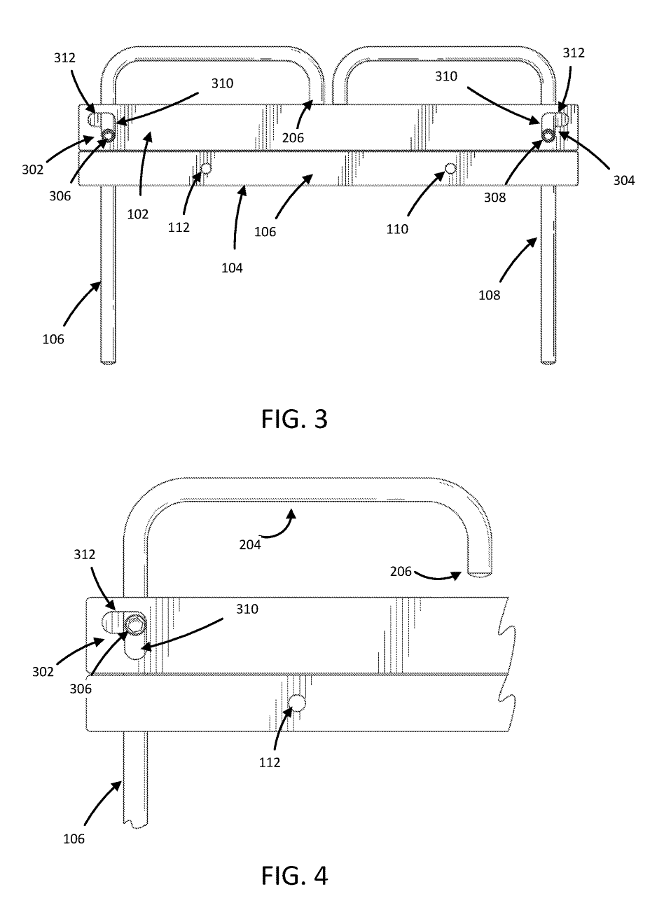

FIG. 3 depicts a front view of the holding unit 100 with the arms 106 and 108 in the retracted position. The upper support 102 includes locking openings 302 and 304. Each locking opening 302 and 304 is substantially “L” shaped and is sized to engage projections 306 and 308 on each arm 106 and 108. The projections engage a vertical portion 310 of each opening 302 and 304 when the arm 106 or 108 is in the retracted position, and a horizontal portion 312 of the opening 302 or 304 when the arm 106 or 108 is in the mounting position. To move the arm 106 or 108 to the mounting position from the retracted position, each arm 106 and 108 is pushed upwards so the projections 306 or 308 moves upward in the vertical portion 310 of the locking opening 302 or 304 until the projection 306 or 308 is aligned with the horizontal portion 312 of the locking opening 302 or 304. When the projection 306 or 308 is aligned with the horizontal portion of the locking opening 302 or 304, the arm is rotated such that the projection 306 or 308 moves into the horizontal portion 312 of the locking opening 302 or 304.

Each projection 306 and 308 is sized such that it extends from the arm 106 or 108 to the top of the locking opening 302 or 304. In one embodiment, the projections 306 and 308 are screws embedded into the base portion 202 of each arm 106 or 108. In another embodiment, the projection 306 or 308 may be welded onto the base portion 202 (FIG. 2) of each arm 106 or 108. In one embodiment, the projections 306 and 308 are positioned on the arms 106 and 108 such that the end 206 or each arm 106 or 108 engages openings 212 or 214 (FIG. 2) when the corresponding projection 306 or 308 is positioned in the bottom of the vertical portion 310 of the corresponding locking opening 302 or 304.

FIG. 4 depicts a close up view of locking opening 302 and projection 306. The locking opening 302 includes the vertical portion 310 and horizontal portion 312 with the projection 306 moving between the vertical portion 310 and horizontal portion 312. When the projection 306 is at the intersection of the vertical portion 310 and horizontal portion 312, the arm 106 is rotated such that the projection rotates into the horizontal portion 312. When the projection 306 is in the horizontal portion 312, the arm 106 is prevented from moving up or down in relation to the upper support 102 thereby affixing the holding unit 100 in the mounting position. Lower support 104 can be positioned at an appropriate position to engage an electronic device via the openings 110 and 112.

As an illustrative example, the arms 106 and 108 of the holding unit 100 may be positioned on a seat. A device, or device mount, is removably secured to the lower support 104. The arms 106 and 108 are positioned in the retracted position with the ends 206 of each arm 106 and 108 being positioned in the openings 212 and 214. To convert the unit 100 from a storage configuration to a mounting configuration, the arms 106 and 108 are pulled away from the lower support 104 thereby pulling the upper support 102 with the arms 106 and 108. When fully extended upward, the arms 106 and 108 are turned such that the projections 306 and 308 move into the horizontal portion 312 of the locking openings 302 and 304. The engagement portion 204 may be positioned on the top surface of the seat with the ends 206 engaging a front surface of the seat. The upper support 102 and lower support 104 engage the rear surface of the seat to allow users situated behind the seat to view the screen of the electronic device.

In one embodiment, the electrical device is secured to the lower support 104 using a hook and latch material adhered to the back of the electrical device and the side of the lower support 104 facing the electrical device. In another embodiment a case holding the electrical device is secured to the lower support 104 using a securing unit, such as a screw, or an adhesive material. In another embodiment, a case holding the electrical device is removably secured to the supports 102 and 104 using clips the secure to the top and bottom portions of the supports. In another embodiment, the electrical device, or a case holding the electrical device, is secured to the supports by a magnetic material secured to the back of the electrical device. Consistent with this embodiment, the supports 102 and 104 are made of a Ferris material, such as steel, that the magnets to which the magnets would adhere. In another embodiment, the arms 106 and 108 and supports 102 and 104 are made from plastic or other suitable material.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

What is claimed:

1. A holding unit including:
an upper support unit;
a lower support unit;
a first arm that engages first openings in the upper support unit and lower support unit;
a second arm that engages second openings in the upper support unit and lower support unit;
at least two locking openings in the upper support that engages a projection on each first arm and each second arm.

2. The holding unit of claim 1 wherein the end of the first arm is substantially curved.

3. The holding unit of claim 1 wherein the end of the second arm is substantially curved.

4. The holding unit of claim 1 wherein the first support and second support move along the first arm and second arm.

5. The holding unit of claim 4 wherein to convert the holding unit from a storage configuration to a mounting configuration, the first arm and second arm are pulled away from the lower support thereby pulling the upper support with the arms.

6. The holding unit of claim 1 including an electronic device secured to the lower support unit.

7. The holding unit of claim 6 wherein the electronic device is secured to the lower support unit by screws.

8. The holding unit of claim 6 wherein the electronic device is secured to the lower support unit by hook and latch material.

9. The holding unit of claim 6 wherein the electronic device is secured to the lower support unit by magnets.

10. The holding unit of claim 1 wherein the arms and support units are made of plastic.

11. A method of securing an electronic device, the method including:
attaching an electronic device to a support unit;
moving a first arm relative to a second arm such that the first arm and second arm move away from one another;
rotating a first are and a second arm such that the first arm and second arm are parallel to one another and are perpendicular to the support units securing the first arm and second arm on a fixture.

12. The holding unit of claim 11 wherein the end of the first arm is substantially curved.

13. The holding unit of claim 11 wherein the end of the second arm is substantially curved.

14. The holding unit of claim 11 wherein the first support and second support move along the first arm and second arm.

15. The holding unit of claim 11 wherein the fixture is a car seat.

16. The holding unit of claim 11 including an electronic device secured to the lower support unit.

17. The holding unit of claim 16 wherein the electronic device is secured to the lower support unit by screws.

18. The holding unit of claim 16 wherein the electronic device is secured to the lower support unit by hook and latch material.

19. The holding unit of claim 16 wherein the electronic device is secured to the lower support unit by magnets.

20. The holding unit of claim 11 wherein the arms and support units are made of plastic.
